(19) United States
(12) Patent Application Publication
(10) Pub. No.: US 2025/0357802 A1
(43) Pub. Date: Nov. 20, 2025

(54) ROTOR OF AN ELECTRIC MACHINE

(71) Applicant: Robert Bosch GmbH, Stuttgart (DE)

(72) Inventors: Bastian Vogt, Backnang (DE); Dietmar Uhlenbrock, Stuttgart (DE); Lin Feuerrohr, Renningen (DE); Manuel Gaertner, Burgstetten (DE); Michael Knorpp, Weissach (DE); Andreas Herzberger, Remseck Am Neckar (DE); Gert Jansen, Peer (BE); Jannik Stammler, Stuttgart (DE); Julian Mueller, Ostfildern (DE); Matthias Steinle, Muehlacker (DE)

(21) Appl. No.: 18/869,410

(22) PCT Filed: May 15, 2023
(86) PCT No.: PCT/EP2023/062929

§ 371 Date: Nov. 26, 2024

(30) Foreign Application Priority Data
Jun. 1, 2022 (DE) 10 2022 205 564.0
Nov. 10, 2022 (DE) 10 2022 211 886.3
Jan. 17, 2023 (DE) 10 2023 200 313.9

(51) Int. Cl. H02K 1/24; H02K 7/00; H02K 19/00

(52) U.S. Cl. CPC H02K 1/24; H02K 7/003; H02K 19/00

(57) ABSTRACT

Rotor (1) of an electric machine, in particular an electrically excited synchronous machine, comprising a rotor shaft (3) which can be rotated about a rotor axis (2), in particular which is a hollow shaft, comprising multiple separate salient poles (4) arranged around a circumferential direction of the rotor (1), which are anchored in a rotor yoke (5), in particular interlockingly, characterized in that the rotor yoke (5) is formed in the motor shaft (3).

### BACKGROUND

The invention proceeds from a rotor of an electric machine.

JP54134304 A2 already discloses a rotor of an electric machine with a rotor shaft that can be rotated about a rotor axis, comprising multiple separate salient poles arranged around a circumferential direction of the rotor, which are anchored in anchoring grooves of the rotor. The anchoring grooves of the rotor are formed in a carrier body located on the rotor shaft, which forms the yoke and is configured as a stack of sheets. It is disadvantageous that the yoke, which is configured as a sheet or a stack of sheets, has a low speed performance. In addition, the carrier body takes up a large amount of radial assembly space.

### SUMMARY

In contrast, the rotor of an electric machine according to the invention with the characterizing features of the disclosure has the advantage that the speed performance of the rotor is increased by the rotor yoke being formed in the rotor shaft.

The higher speed strength results from the rotor shaft being made from material that is not composed of sheets, i.e. a solid material. Using a rotor shaft that is not composed of sheets as a rotor yoke also allows easier joining of the salient poles than if both items to be joined were composed of sheets. By integrating the carrier body from prior art into the rotor shaft, the complex step of attaching the carrier body to the rotor shaft is eliminated, in particular, by means of pressing. The rotor shaft according to the invention is thus designed without a hub. Manufacturing costs are reduced as a result.

According to one advantageous embodiment, the rotor shaft is configured as a body not made of sheets and the salient poles are each pole bodies composed of sheets. With this pairing, planar contact surfaces result in the rotor shaft, so that the salient poles are aligned more precisely during joining. In addition, there is less variation in speed performance.

It is particularly advantageous when the salient poles are anchored to an anchoring ledge on the rotor shaft, which is an integral component of the rotor shaft and is, in particular, cylindrical. In this way, the rotor carrier from prior art is integrated into the rotor shaft in a single piece.

It is further advantageous if anchoring grooves are formed on the anchoring ledge of the rotor shaft according to the two exemplary embodiments, into which a protruding pole anchor of one of the leg poles extends. Alternatively, anchoring protrusions may be formed on the anchoring ledge of the rotor shaft, which each extend into a pole recess of one of the salient poles.

It is very advantageous if the pole anchor or the pole recess of the salient poles each has an anchoring profile, which is in particular pine-shaped, tree-shaped, T-shaped, dovetail-shaped, triangular, rectangular or square. In this way, very solid anchoring of the salient poles can be achieved.

It is also advantageous if the anchoring grooves or the anchoring projections of the rotor shaft each comprise an anchoring counterprofile for interlocking with the anchoring profile of the salient poles. In this way, very solid anchoring of the salient poles can be achieved.

Furthermore, it is advantageous if, according to the two exemplary embodiments, the anchoring grooves of the rotor shaft each comprise two groove walls, wherein tooth flanks are formed on the groove walls of the respective anchoring groove, which extend in the axial direction relative to the rotor axis and form rear sections of the anchoring counter profile and which are, in particular, formed in a triangular or sawtooth shape. In this way, very deep radial anchoring of the salient poles in the rotor shaft and, thus, very high speed performance can be achieved.

Moreover, it is advantageous if a plurality of tooth flanks is arranged radially relative to the rotor axis, one behind the other, per groove wall of the respective anchoring groove of the rotor shaft. In this way, speed performance may be increased even further.

Advantageously, if the anchoring ledge of the rotor shaft is a shaft shoulder with the largest radial extension and two shaft shoulders are provided adjacent to the anchoring ledge with a radially smaller extension, wherein the adjacent shaft shoulders, according to a second exemplary embodiment, have outlet grooves that lead into the anchoring grooves of the anchoring ledge and, in particular, have a greater width than the anchoring grooves. In this way, a groove bottom of the anchoring grooves can be placed radially even deeper in the rotor shaft so that the speed performance can be increased even further due to a higher number of tooth flanks. In addition, the outlet grooves of the rotor shaft act as a joining aid for axially feeding the pole anchors into the anchoring grooves of the rotor shaft.

In addition, it is advantageous if the anchoring ledge of the rotor shaft is longer in the axial direction with respect to the rotor axis than the salient poles, in particular by more than half a sheet thickness of a lamination of one of the salient poles. As a result, no individual laminations of the respective salient pole are partially or completely outside of the respective anchoring groove when viewed in the axial direction, so that it is ensured that each lamination of the individual salient poles is anchored directly to the rotor shaft and not indirectly via adjacent laminations of the respective salient pole.

The invention also relates to an electric machine comprising a rotor according to the invention.

### BRIEF DESCRIPTION OF THE DRAWINGS

An exemplary embodiment of the invention is shown in simplified form in the drawing and explained in more detail in the following description.

FIG. 1 shows a section of a rotor according to the invention according to a first exemplary embodiment,

FIG. 2 shows a rotor shaft according to the invention of the rotor according to FIG. 1,

FIG. 3 shows a rotor according to the invention according to a second exemplary embodiment and

FIG. 4 shows the rotor shaft according to the invention of the rotor according to FIG. 3.

### DETAILED DESCRIPTION

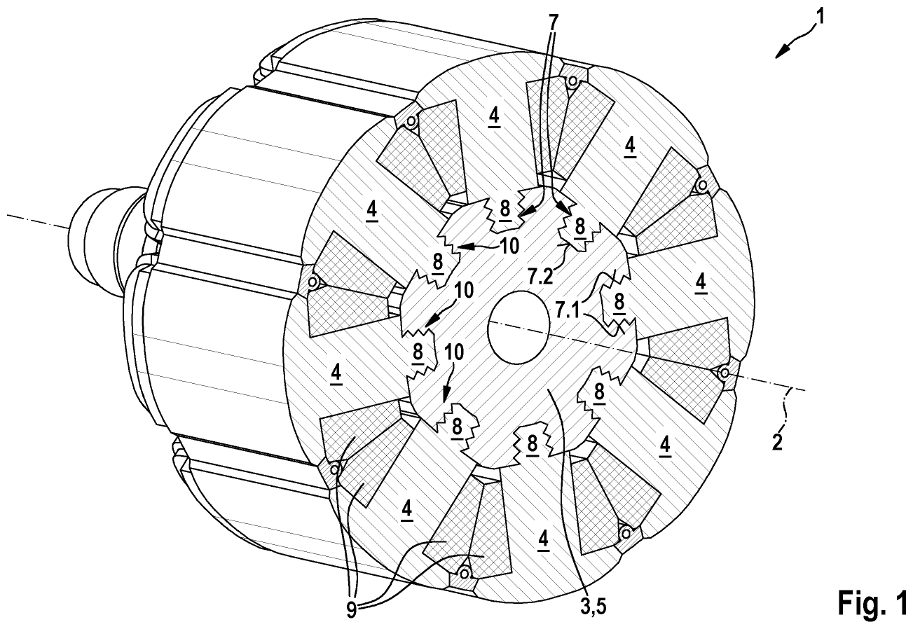

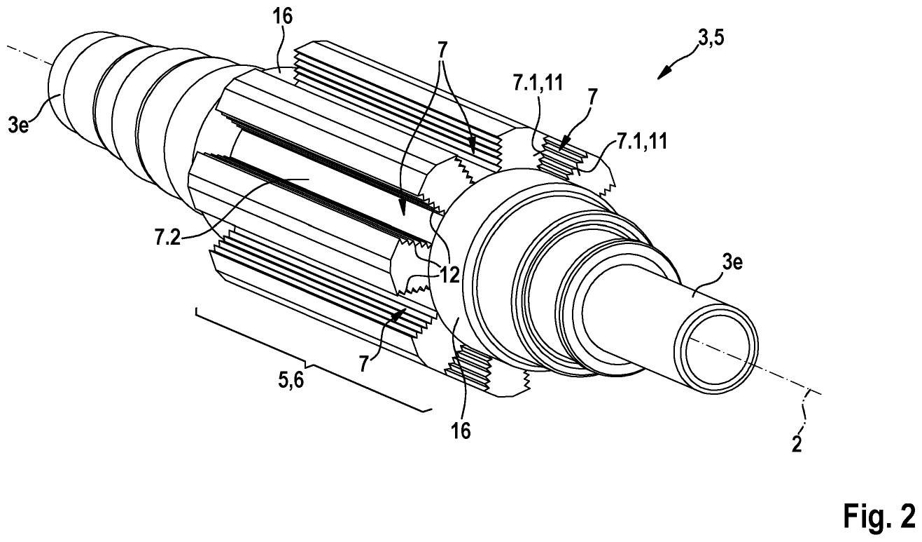

FIG. 1 shows a cross section of a rotor according to the invention according to a first exemplary embodiment. FIG. 2 shows a rotor shaft according to the invention of the rotor according to FIG. 1.

The rotor 1 of an electric machine according to the invention, in particular an electrically excited synchronous machine, comprises a rotor shaft 3 which is rotatable about a rotor axis 2, which is in particular a hollow shaft, and multiple of separate salient poles 4 arranged around a circumferential direction of the rotor 1, which are anchored in a rotor yoke 5, in particular in an interlocking manner. A rotor winding 9 is provided between the salient poles 4, which comprises, for example, individual coils that each extend around one of the salient poles 4.

According to the invention, it is foreseen that the rotor yoke 5 is configured in the rotor shaft 3.

The rotor shaft 3 is a body that is not composed of sheets, while the salient poles 4 are each configured as a pole body made from sheets. The pole bodies of the salient poles 4 are thus each designed as a stack of sheets.

The salient poles 4 of the rotor 1 are anchored to an anchoring ledge 6 of the rotor shaft 1. The anchoring ledge 6 of the rotor shaft 1 is configured as an integral part of the rotor shaft 1 and is, in particular, cylindrical.

According to the two exemplary embodiments, anchoring grooves 7 are formed on the anchoring ledge 6 of the rotor shaft 1, into which a radially projecting pole anchor 8 of one of the salient poles 4 extends. The pole anchor 8 of the salient pole 4 extends in the axial direction, for example, over the entire length of the salient pole 4, and is part of the stack of sheets comprising the salient pole 4, for example.

Alternatively, anchoring protrusions may be formed on the anchoring ledge 6 of the rotor shaft 1 in a manner not shown, with each extending into a pole recess of one of the salient poles 4. The pole anchor 8 or the pole recess of the salient poles 4 each has an anchoring profile 10, which is, for example, pine-shaped, tree-shaped, T-shaped, swallowtail-shaped, triangular, rectangular or square. The anchoring grooves 7 or the anchoring projections of the rotor shaft 1 each have an anchoring counter profile 11 for interlocking with the anchoring profile 10 of the salient poles 4.

The anchoring grooves 7 of the rotor shaft 1 each have two groove walls 7.1 and a groove bottom 7.2 and are milled, for example. At the groove walls 7.1 of the respective anchoring groove 7, for example, triangular or sawtooth-shaped tooth flanks 12 are formed that extend in the axial direction relative to the rotor axis 2 and form indentations in the anchoring counter profile 11. Correspondingly, the walls of the anchoring profile 10 of the pole anchors 8 also have corresponding tooth flanks 12.

For example, a plurality of tooth flanks 12 are arranged, one behind the other, in a radial direction with respect to the rotor axis 2 per groove wall 7.1 of the respective anchoring groove 7. For example, the groove bottom of the anchoring grooves 7 is at a constant radial level or a constant radius along the axial extension.

The anchoring ledge 6 of the rotor shaft 1 is a shaft shoulder with the greatest radial extension. Two shaft shoulders 16 adjacent to the anchoring ledge 6 are foreseen with radially smaller extension, such that the anchoring ledge 6 lies between the two adjacent shaft shoulders 16. The rotor shaft 1 also includes two shaft ends 3e, between which the anchoring ledge 6 and the two adjacent shaft shoulders 16 are located.

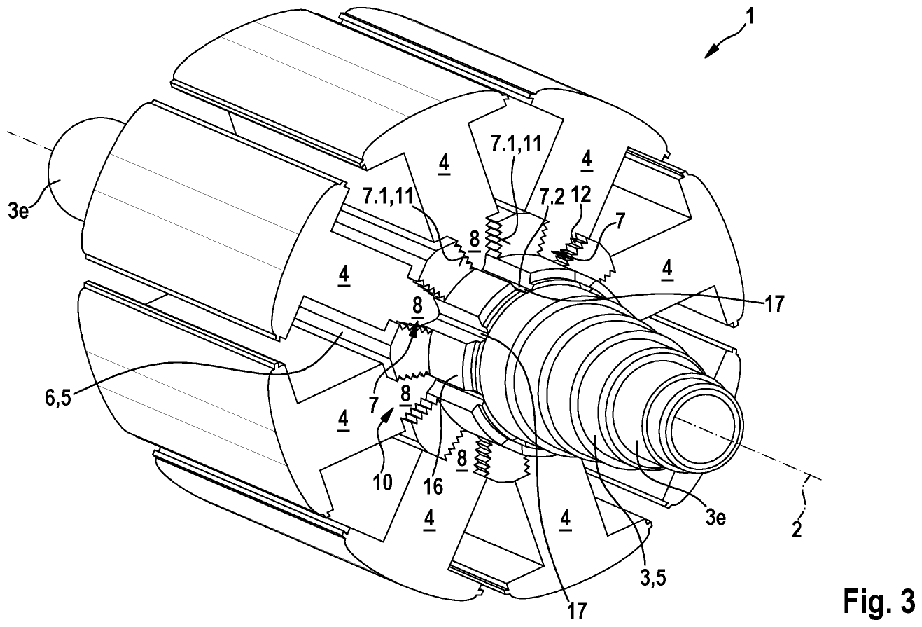

The anchoring ledge 6 of the rotor shaft 1 may—as shown in FIG. 3—be longer in the axial direction with respect to the rotor axis 2 than the salient poles 4 by more than half a sheet thickness, in particular by one or more sheet thicknesses, of a lamination of one of the salient poles 4.

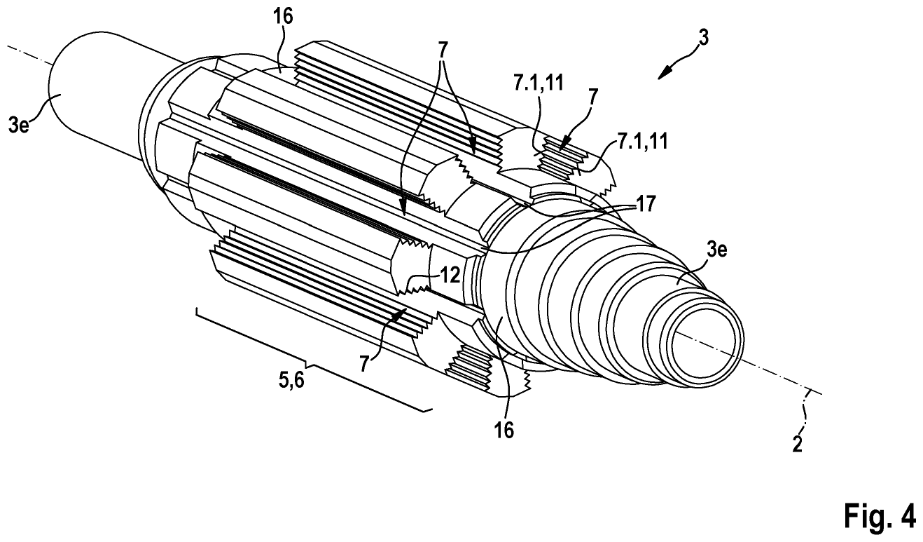

FIG. 3 shows a rotor according to the invention according to a second exemplary embodiment. FIG. 4 shows the rotor shaft of the rotor according to the invention according to FIG. 3.

The second exemplary embodiment differs from the first exemplary embodiment only in that the adjacent shaft shoulders 16 comprise outlet grooves 17 that lead into the anchoring grooves 7 of the anchoring ledge 6 and that, for example, have a greater (in a circumferential direction to be measured) width than the anchoring grooves 7 for facilitating axial insertion. The outlet grooves 17 may continuously narrow towards the anchoring grooves 7 in the circumferential direction. Alternatively or additionally, a lead-in chamfer may be provided at the transition from the respective outlet groove 17 to the respective anchoring groove 7. The outlet grooves 17 are also milled, for example.

The groove bottom of the anchoring grooves 7 and the groove bottom of the outlet grooves 17 lie along the axial extension, for example, at the same radial level or the same radius.

The anchoring grooves 7 according to the second exemplary embodiment have a greater radial depth than in the first exemplary embodiment, so that even more tooth flanks 12 per groove wall 7.1 are possible, whereby the speed performance can be further increased.

1. A rotor (1) of an electric machine, comprising: a rotor shaft (3) which can be rotated about a rotor axis (2), the rotor shaft (3) comprising multiple separate salient poles (4) arranged around a circumferential direction of the rotor (1), which are anchored in a rotor yoke (5), wherein the rotor yoke (5) is formed in the rotor shaft (3).

2. The rotor according to claim 1, wherein the rotor shaft (3) is a body that is not comprised of sheets and the salient poles (4) are each formed as a pole body made from sheets.

3. The rotor according to claim 1, wherein the salient poles (4) are anchored to an anchoring ledge (6) of the rotor shaft (3), which is integrally formed on the rotor shaft (3).

4. The rotor according to claim 3, wherein the anchoring ledge (6) of the rotor shaft (3) comprises anchoring grooves (7), into which a protruding pole anchor (8) of one of the salient poles (4) extends, or wherein anchoring protrusions are formed on the anchoring ledge (6) of the rotor shaft (3), which each extend into a pole recess of one of the salient poles (4).

5. The rotor according to claim 4, wherein the pole anchor (8) or the pole recess of the salient poles (4) each comprises an anchoring profile (10), which is pine-shaped, tree-shaped, T-shaped, swallowtail-shaped, triangular, rectangular or square.

6. The rotor according to claim 5, wherein the anchoring grooves (7) or the anchoring protrusions of the rotor shaft (3) each comprise an anchoring counter profile (11) for interlocking with the anchoring profile (10) of the salient poles (4).

7. The rotor according to claim 6, wherein the anchoring grooves (7) of the rotor shaft (3) each have two groove walls (7.1), wherein tooth flanks (12) are formed on the groove walls (7.1) of the respective anchoring groove (7), which extend in an axial direction with respect to the rotor axis (2) and form indentations on the anchoring counter profile (11).

8. The rotor according to claim 7, wherein a plurality of tooth flanks (12) are arranged, one after another, in a radial direction with respect to the rotor axis (2) per groove wall (7.1) of the respective anchoring groove (7).

9. The rotor according to claim 4, wherein the anchoring ledge (6) of the rotor shaft (3) is a shaft shoulder with a largest radial extension and two shaft shoulders (16) are provided adjacent to the anchoring ledge (6) with a radially smaller extension, wherein the adjacent shaft shoulders (16) have outlet grooves (17) that lead into the anchoring grooves (7) of the anchoring ledge (6).

10. The rotor according to claim 3, wherein the anchoring ledge (6) of the rotor shaft (3) is configured longer in an axial direction with respect to the rotor axis (2) than the salient poles (4).

11. An electric machine with a rotor (1) according to claim 1.

12. The rotor (1) according to claim 1, wherein the electric machine is an electrically excited synchronous machine.

13. The rotor (1) according to claim 1, wherein the rotor shaft (3) is hollow.

14. The rotor (1) according to claim 1, wherein the multiple separate salient poles (4) are anchored interlockingly in the rotor yoke (5).

15. The rotor (1) according to claim 3, wherein the anchoring ledge (6) is cylindrical.

16. The rotor (1) according to claim 7, wherein the indentations on the anchoring counter profile (11) are triangular or sawtooth-shaped.

17. The rotor (1) according to claim 9, wherein the outlet grooves (17) have a greater width than the anchoring grooves (6).

18. The rotor (1) according to claim 10, wherein the anchoring ledge (6) of the rotor shaft (3) is configured longer in the axial direction with respect to the rotor axis (2) than the salient poles (4) by more than half a sheet thickness of a lamination of one of the salient poles (4).
